(19) United States
(12) Patent Application Publication
(10) Pub. No.: US 2024/0375118 A1
(43) Pub. Date: Nov. 14, 2024

(54) PYRAMID LINING FOR MILL DRUM

(71) Applicant: TEGA INDUSTRIES LIMITED, Kolkata, West Bengal (IN)

(72) Inventors: Abhishek SINHA, Patna, Bihar (IN); Juan Eduardo Bustamante HERNANDEZ, Valparaiso (CL)

(21) Appl. No.: 18/286,237

(22) PCT Filed: Nov. 26, 2022
(86) PCT No.: PCT/IN2022/051033

§ 371 Date: Oct. 10, 2023

(30) Foreign Application Priority Data
Dec. 4, 2021 (IN) 202131056287

(51) Int. Cl. B02C 17/22

(52) U.S. Cl. CPC B02C 17/225; B02C 2210/01

(57) ABSTRACT

A pyramid lining insert/element for mill drum of a grinding mill, comprising of a structural and positional formation of pyramid inserts configured with a front lifter part that extends a first side of the liner member with a defined height and a real lifter part that extends to the rear side conforming shape of pyramid of the said liner member; wherein both the front and rear lifter part having an height; and wherein the said front and rear lifter part are adjacent to each other along the side of the said pyramid shaped lining member and have a front and rear support plate beneath the said front and rear lifter part in order to support the lifter plate and also to provide a robust and solid lining member.

### FIELD OF THE INVENTION

The present invention in general relates to the mining industry, and refers to compounded linings for grinding mills with an element of metal rubber anti-wear with visual indicator of level of wear by means of disposition of steel plates. More Particularly, this technology refers to an interior wear protection element for grinding mills compounded by a combination of wear high-strength steels embedded into a rubber matrix, in such configuration layout that allows to obtain a high-performance protection element and in turn its steel-alternate configuration allows to determine the level of wear upon visual inspection.

### BACKGROUND OF THE INVENTION

There are several technologies to estimate the level of wear. There are those based in comparative measurement such as the direct measurement so far as the 3D laser scanner estimates and assessment by means of scatter plots software, also there are electronic devices that are able to determine the wear by using cables inserted into the parts. Configuration and layout of wear-resistant steels in these linings mainly aim to maximize the abrasion resistance during the grinding process. Currently, there are countless types of mill linings, from solid steel elements, being of various qualities and strengths, to linings known as hybrid, which are a combination of wear resistant steels placed in a polymer matrix such as rubber.

As already mentioned, the mills for such purposes must have a wear and abrasion resistant inner side. Therefore, the mills are often provided with a lining of abrasion resistant material, such as elastomeric or plastic material, ceramic material or sometimes steel material. The lining of abrasion resistant material is usually fastened by mechanical means such as fastening bolts, clamping ribs or like means.

Mill linings mainly have two tasks. One is to provide a protection for the mill barrel and the end walls thereof against mechanical and corrosive abrasion, and the other is to transmit energy from the mill to the charge. This implies that the appearance of the inner side of the mill, the so-called profile, is of great importance to the grinding capacity.

In conventional mill linings having longitudinal shell plates and so-called lifters, it is important that said lifters are replaced when they have been subjected to so heavy an abrasion that the charge begins to slide along the lining. When the lifters are exposed to sliding abrasion, they are thus subjected to accelerated wear, and as a consequence the interjacent shell plates will also commence to be rapidly worn. To realize a good lining economy the lifters therefore have to be replaced in due time; after a change of lifters the grinding capacity may often be lowered by 10-20%.

Exchange of lifters and barrel plates involves quite some costs in terms of dismounting and mounting as well as standstill costs.

It would be highly desirable that a mill lining could be worn to the same extent all over the lining and that the life thereof could be extended to periods of one year or more so that the necessary exchanges could be performed during normal standstill periods, that is the holiday period.

Currently, there are countless types of mill linings, from solid steel elements, being of various qualities and strengths, to linings known as hybrid, which are a combination of wear resistant steels placed in a polymer matrix such as rubber. During the mill shutdown, to inspect the linings it is of great importance to determine the level of wear in order to be able to project the remaining service life and to schedule longer shutdown for the replacement of those parts.

There are several technologies to estimate the level of wear. In one hand, there are those based in comparative measurement such as the direct measurement so far as the 3D laser scanner estimates and assessment by means of scatter plots software, also there are electronic devices that are able to determine the wear by using cables inserted into the parts.

Configuration and layout of wear-resistant steels in these linings mainly aim to maximize the abrasion resistance during the grinding process.

Additionally, this steel layout in the wear protection element allows to reduce the transverse polymer area exposed to abrasion, thus achieving a more uniform wear than in the prior art, therefore, the protection element behaves more like a solid steel block than a polymer-metal mixed matrix.

On the other hand, this steel layout in the wear protection element gives anchorage space beneath the anti-abrasive plates to allocate fastening items. Thus, the wear protection element has a higher thickness of useful wear because it reduces the thickness reserved to embed the fastening items.

In the prior art, a PCT publication WO2020136488 discloses lifter bar for a grinding mill comprises of an elongate structural support defining a longitudinal axis and extending from (i) a first end transverse to the longitudinal axis to (ii) a second end transverse to the longitudinal axis; a plurality of structural plates extending along the longitudinal axis in spaced relation, where each structural plate is transverse to the longitudinal axis, and defines opposed edges. The lifter bar may further comprise at least two protective plate portions, each protective plate portion being mounted over one set of the opposed edges.

In another prior art, a PCT publication WO2010017589 discloses method of fabricating a liner component for a grinding mill including the steps of: providing a plate of hard material; cutting the plate to form a plurality of inserts, at least some of the inserts including a formation for mechanically engaging with a body of a resilient material; arranging the inserts in a mould, and-adding resilient material to the mould to form a resilient material body around the inserts to thereby form the liner component.

The closest prior art does not provide the indication of visual wear. It discloses a polymer lining with metal anti-abrasive reinforcement including four protective plates in the shape of anti-abrasive steel covers. The structural supports of the closest prior art are not anti-abrasive elements in the form of continuous plate, but to multiple triangular supports placed with the purpose of providing rigidity to the part. The present invention meets the abovementioned long felt needs.

### OBJECTS OF THE INVENTION

It is the principal object of the present invention to provide a configured layout of lining insert/element that allows to obtain a high-performance protection element and allow to determine the level of wear upon visual inspection by means of its steel-alternate configuration.

### SUMMARY OF THE INVENTION

Accordingly, the present invention provides a configuration layout that allows obtaining a high-performance protection element and in turn its steel-alternate configuration allows determining the level of wear upon visual inspection.

During the mill shutdown, to inspect the linings it is of great importance to determine the level of wear in order to be able to project the remaining service life and to schedule longer shutdown for the replacement of those parts. Additionally, this steel layout in the wear protection element allows to reduce the transverse polymer area exposed to abrasion, thus achieving a more uniform wear than in the prior art, therefore, the protection element behaves more like a solid steel block than a polymer-metal mixed matrix. Also, this steel layout in the wear protection element gives anchorage space beneath the anti-abrasive plates to allocate fastening items. Thus, the wear protection element has a higher thickness of useful wear because it reduces the thickness reserved to embed the fastening items.

In accordance with a principle embodiment of the present invention, a mill liner insert/element is structured and compounded by a combination of wear high-strength steels embedded into a rubber matrix, in such configuration layout that allows to obtain a high-performance protection element and in turn its steel-alternate configuration allows to determine the level of wear upon visual inspection. The wear resistant high strength steel inserts are configured and oriented within the rubber matrix to provide a liner element that is less prone to wear, cracking compared to conventional all-metal mill lining elements, and which provides visual assessment of wear and further ease of handling and replacement when worn. A multiplicity of mill liner elements are positioned in a grinding mill shell and are suitable for use in a variety of types of grinding mill structures, including ball mills and both AG (autogenous grinding) and SAG (semi-autogenous grinding) mills.

The mill liner of this disclosure comprises an elongated mill liner member that is generally structured for positioning along the inner wall of a grinding mill drum or shell in the direction of the rotational axis of the drum. The mill liner is formed with a base surface with fastening arrangement that is oriented along the inner wall of a grinding mill drum or shell. The pyramidal inserts are configured to be used with liner members during mill operation.

As per another embodiment, the disclosed liner is in a structural formation of a pyramid inserts configured with a front lifter part that extends a first side of the liner member and has a defined height. The liner is also configured with a rear lifter part that extends to the rear side of the said pyramid shaped liner member, where both the front and rear lifter part having an equal height. The front and rear lifter part are adjacent to each other along the side of the pyramid shaped lining member and have a front and rear support plate beneath the said front and rear lifter part in order to support the lifter plate and also to provide a robust and solid lining member.

As per yet another embodiment a plurality of pyramidal inserts placed in a polymer matrix such as rubber of the liner element along the length of the liner member. The pyramidal structured steel inserts are generally configured, and are oriented in the elongated elastomer liner member, to provide an outwardly-oriented impact surface that is less than the area of the insert that is oriented perpendicular to the impact surface. The inserts may be of any suitable configuration, but may, in one embodiment disclosed herein, be formed with a configuration similar to the cross sectional configuration of the liner member by having an evenly distributed inserts over the total inner surface of mill drum.

The plurality of single pyramidal inserts is positioned in a parallel and/or unparalleled array adjacent each other along a length of the mill liner member. The plurality of inserts may be positioned at an angle perpendicular to the longitudinal axis of the elongated elastomer liner member. Most suitably, however, the plurality of inserts may be positioned at an angle to the longitudinal axis of the elongated elastomer liner member. The non-elastomeric inserts may be made of any suitable material that imparts strength and impact-resistance to the mill liner element, such as steel or other suitably durable materials.

As per yet another embodiment, there is provided a base plate member, formed along, and preferably embedded on the base surface of the said pyramidal insert liner member. The base plate may be made of any suitably strong material, preferably steel. The base plate is oriented for positioning against the inner wall of the grinding mill drum, and provides stability to the mill liner element and means for securing the mill liner element to the grinding mill drum.

As per yet another embodiment, there is provided a multilayered pyramidal robust lining, designed and capable/configured for quick assessment of the wear of linings by visual inspection, enabling reduced shutdown time for the replacement/repair of the mill drum.

As per yet another embodiment there is provided a double pyramidal insert or triple pyramidal insert preferably in the form of sets disposed over the total inner surface of mill drum.

In a second aspect, embodiments are disclosed of a plurality of mill liner elements of the first aspect structured in combination with a grinding mill shell having a continuous cylindrical wall encircling a rotational axis. In this arrangement the mill liner, elements are positioned adjacent each other along the circumferential inner wall of the shell or drum. In one arrangement, each of the mill liner elements is fastened to the wall of the mill shell. As structured, the liner element of the first aspect may replace both the lifter bar and liner plate.

### BRIEF DESCRIPTION OF THE ACCOMPANYING DRAWINGS

The nature and scope of the present invention will be better understood from the accompanying drawings, which are by way of illustration of a preferred embodiment and not by way of any sort of limitation. In the accompanying drawings:—

FIG. 1 is a view of a section of pyramid type lining in accordance with the present invention;

FIG. 2a is a view of an arrangement in grinding mill by single pyramid type lining according to the present invention;

FIG. 2b is a view of the grinding mill shell fitted with single pyramid type according to the present invention;

FIG. 3a is a view of an arrangement in grinding mill by double pyramid type lining according to the present invention;

FIG. 3b is a cross-sectional view of the grinding mill shell fitted with double pyramid type according to the present invention;

FIG. 4a is a view of an arrangement in grinding mill by triple pyramid type lining according to the present invention;

FIG. 4b is a cross-sectional view of the grinding mill shell fitted with triple pyramid type according to the present invention;

FIG. 5a is a view of an arrangement in grinding mill by single pyramid type lining with aluminum channel according to the present invention;

FIG. 5b is a cross-sectional view of the grinding mill shell fitted with triple pyramid type according to the present invention;

FIG. 6a is a view of an arrangement in grinding mill by single pyramid type lining for use in Mill head according to the present invention;

FIG. 6b is a cross-sectional view of the assembly condition in head according to the present invention;

FIG. 7 illustrates the pyramid type lining wear trend analysis under visual inspection during use according to the present invention.

FIG. 8 (a) illustrates the pyramid type lining consists of multilayer of Steel bonded by a polymer in between, according to the present invention;

FIG. 8 (b) illustrates the second phase as soon as the wear mechanism start to progress, according to the present invention

FIG. 8 (c) illustrates the third and subsequent phases work in a similar way as shown in FIG. 8 (c), according to the present invention;

FIG. 9 illustrates view of the wear profile at the end of trial done in a SAG34×17 in order to compare the performance between typical steel liner against a pyramid design according to the present invention;

FIG. 10 illustrates final inspection of wear profile after 6 month of operation and around 18M ton processed according to the present invention

The nature and scope of the present invention will be better understood from the accompanying drawings, which are by way of illustration of a preferred embodiment and not by way of any sort of limitation.

### DETAILED DESCRIPTION

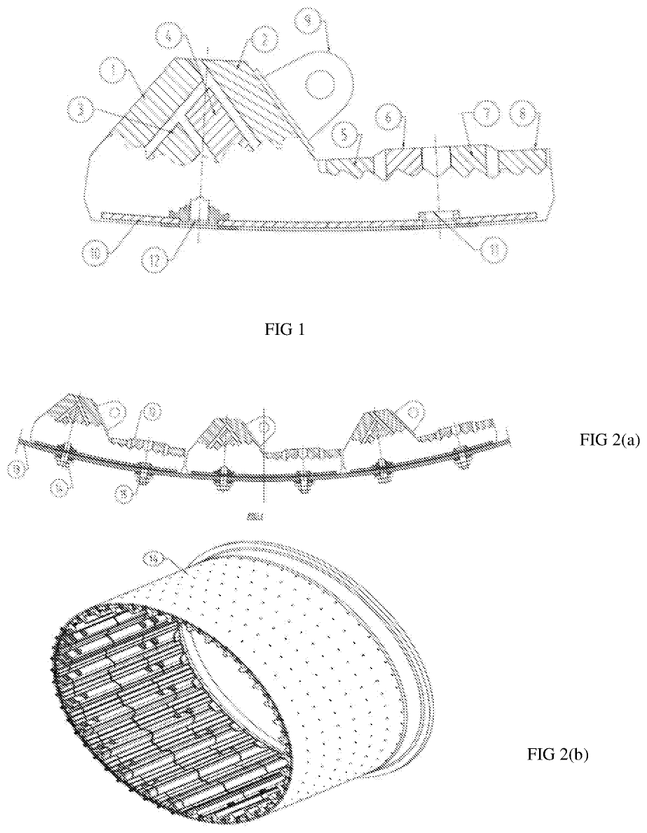

Referring to the drawings, FIG. 1 illustrates the section of pyramid type insert/element which is pyramidal structured and compounded by a combination of wear high-strength steels embedded into a rubber matrix, in such configuration layout that allows to obtain a high-performance protection element and in turn its steel-alternate configuration allows to determine the level of wear upon visual inspection. The mill liner element has a length L extending between a first end and a second end, and a longitudinal axis. The longitudinal axis of the mill liner element is conventionally parallel to the axis of rotation of a grinding mill shell or drum. The dimension of the length L of the mill liner element may, in one conventional form, be sized to extend over the entire length of the grinding mill drum or shell (i.e., as measured in the direction of rotational axis of the grinding mill shell). However, the mill liner element may be sized in length L to be less than the length of the grinding mill shell, such that one and/or more than one mill liner element may be placed end-to-end to extend over the length of the grinding mill shell, most commonly with at least two elements in an end-to-end configuration.

FIG. 2 illustrates the mill liner element arrangement in grinding mill by single pyramid type lining in cross section. It can be seen that the mill liner element comprises a pyramid shaped liner member having a width W and a base surface that extends substantially the width of the mill liner element and is oriented for positioning along the inner wall of a grinding mill shell as illustrated in FIG. 2(b). The liner base has a curvilinear contour made of polymeric material embedded with steel or aluminium, and its dimension depends on the internal diameter of the mill. A steel/aluminium backing plate member is formed or extends along the base surface of the pyramid shaped liner member. The backing plate member may be a single, continuous length that extends substantially the length L of the mill liner element. Alternatively, the backing plate member may comprise a plurality of lengths of polymeric material that are positioned adjacent each other along the length L of the mill liner. The backing plate member may be made of any suitably strong and durable material, such as stainless steel, steel or alloy, aluminium alloy.

A plurality of said pyramid shaped liner member inserts are embedded on the grinding mill shell in a spaced apart array with polymeric rubber material positioned between adjacent inserts. The plurality of inserts is preferably positioned in parallel/unparalleled and adjacent series along the length L of the mill liner element, as shown in FIG. 2 (b). The inserts may be oriented in a direction that is perpendicular to the longitudinal axis of the mill liner element.

As illustrated in FIG. 1, the pyramid shaped element/insert are spaced apart from each other in series along the length of the lining. The inserts may be spaced from each other so that the width W between adjacent inserts along the length of the pyramid shaped member is equal. Alternatively, the width W between adjacent inserts may vary down the length of the pyramid shaped member. The width W of the spacing between inserts may be selected as per the mill use.

The pyramid shaped inserts embedded in the lining may be made of any suitable material that is durable and able to withstand the impact of the solids being processed in a grinding mill. One exemplary material is steel. In general, each insert/element is formed as a multi-layered plate of material having a thickness T, as shown in FIG. 1, which defines an impact edge that is oriented in a direction away from the base surface. The structural formation of a pyramid inserts configured with a front lifter part that extends a first side of the liner member and has a defined height. The liner is also configured with a rear lifter part that extends to the rear side of the said pyramid shaped liner member, where both the front and rear lifter part having a height. The front and rear lifter part are adjacent to each other along the side of the pyramid shaped lining member and have a front and rear support plate beneath the said front and rear lifter part in order to support the lifter plate and also to provide a robust and solid lining member. The thickness T of the inserts may be from about 25 mm to about 150 mm.

This steel layout in the wear protection element allows to reduce the transverse rubber area exposed to abrasion, thus achieving a more uniform wear than in the prior art, therefore, the protection element behaves more like a solid steel block than a rubber-metal mixed matrix like Pyramid shape. Also, this steel layout in the wear protection element gives anchorage space beneath the anti-abrasive plates to allocate fastening items. Thus, the wear protection element has a higher thickness of useful wear because it reduces the thickness reserved to embed the fastening items.

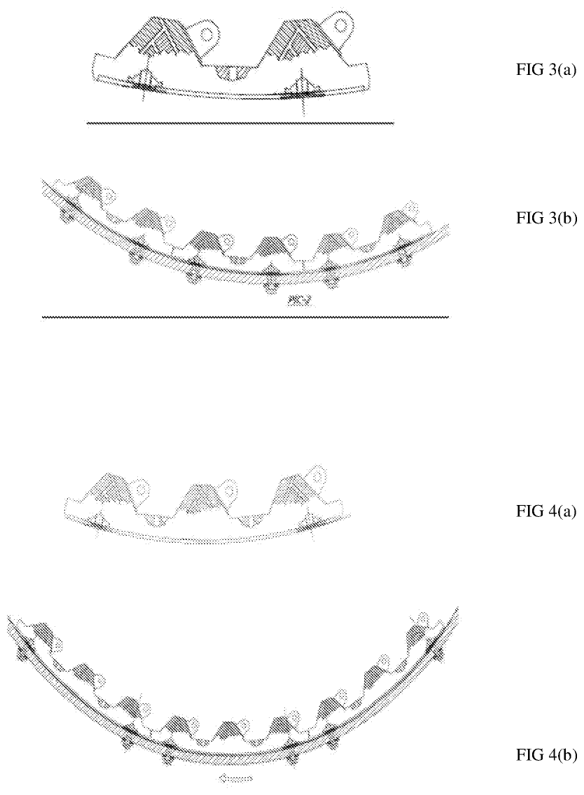

The pyramid shaped inserts are further configured with opposing, spaced apart surfaces which define the thickness T of the insert. The opposing surfaces may generally extend in a perpendicular direction relative to the longitudinal axis of the liner element and perpendicular to the impact surface of the insert. Each insert also has a defined height H, as illustrated in FIG. 2, where the height H of the insert is greater than the thickness T of the insert. The inserts may be formed in any number of varying configurations including duplets and triplets as shown in FIGS. 3 and 4 respectively.

The cross sectional configuration of the mill liner element using single, duplet or triplet may vary depending on the application in which the grinding mill will be used. The mill liner element, however, is generally configured to provide elements of both a shell or liner plate and a lifter bar. Consequently, the pyramid shaped liner member, as illustrated in FIGS. 1 and 2, is generally extends a length of the elongated liner member and has a height. The liner member is also configured with a multiple inserts/elements that extend a length.

In the embodiment described, the inserts are formed with a channel, as seen in FIG. 2, into which the polymeric rubber material is introduced, thereby providing a secure attachment of the pyramid shaped inserts to the lining member. Other methods known to those of skill in the art may be employed to form pyramid shaped inserts to form the mill lining.

The mill liner element is further formed with means for attaching the mill liner insert to a grinding mill shell, as illustrated in FIGS. 1 and 2. As shown a number of lining channels may be formed through the mill liner element through which fastening means may be positioned. The said channels extend through the backing plate, which provides an anchoring device for the fastening apparatus, and into the shell. The fastening apparatus may be any suitable device, such as bolts, having associated washers and nuts.

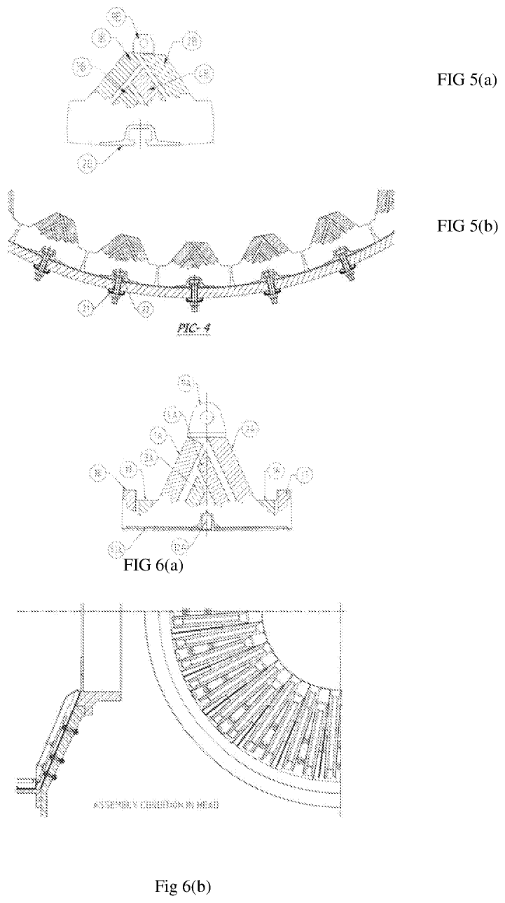

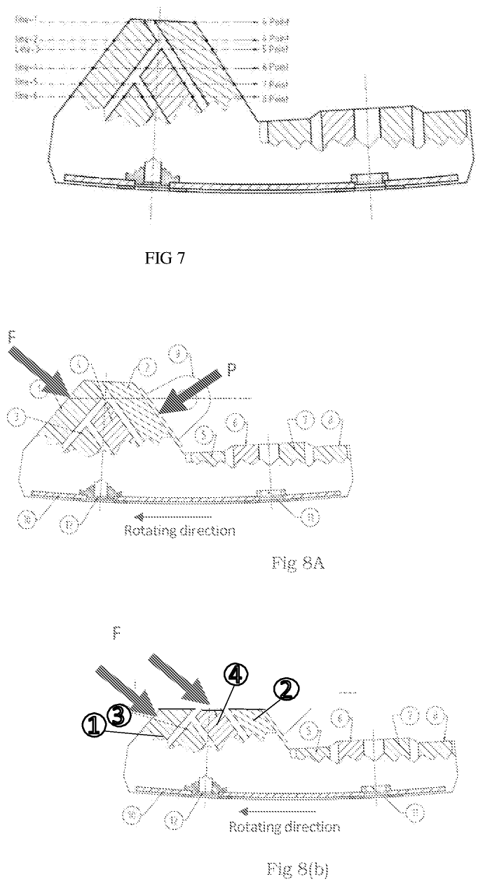

FIGS. 4 and 5 illustrate the positioning of a plurality of mill liner elements along the inner circumferential wall of a grinding mill shell is parallel or non-parallel. The mill elements are positioned adjacent to each other about the entire inner wall of the grinding mill shell with the longitudinal axis of each mill liner element being oriented parallel to the rotational axis of the grinding mill shell. It can be seen from FIGS. 4 and 5 that the base surface, and thus the backing plate of each mill liner element, may be curved to conform to the curvature of the mill shell.

FIG. 2(b)-5(b) shows a plan view of a portion of a grinding mill illustrating three mill liners positioned adjacent to each other. The direction of rotation of the grinding mill shell is illustrated by arrow. It may be noted that the mill liners may preferably be placed adjacent to each other so that there is essentially no spacing between adjacent mill liners. It is also possible, however, to arrange the mill liners in both side-by-side and end-to-end arrangement along the inner wall of the shell so that the mill liners are slightly spaced apart.

The mill liner element design disclosed herein presents particular advantages over conventional mill liners. First, providing a plurality of inserts that are spaced apart and separated by a thickness of an elastomer material reduces the failure rate experienced with all steel mill liners. The elastomer material cushions the inserts to reduce the force of impact on the inserts. Second, if the inserts should crack or break, they are held in place by the surrounding elastomer material, thereby preventing dangerous conditions experienced with broken and falling sections of conventional steel liners. By virtue of their configuration, the mill liners disclosed herein may provide extended service life over conventional steel liners, thereby reducing downtime of the grinding mill and reducing repair costs.

The design of the mill liner element disclosed herein imbues the mill liner element with less weight, thereby reducing transport costs, and making handling of the mill elements considerably easier than conventional steel liners. Moreover, the reduced weight of the mill liners results in extended service life of the grinding mill because less weight and wear is placed on the mill bearings and bull gear. The elastomer material of the mill liner elements also reduces the noise level during operation of the grinding mill, resulting in less damage to the hearing of mill workers.

Further, the design of the mill element also provides a wear element as well as a lifter bar element, thereby eliminating the need for two separate elements as is conventional in the art. Thus, the mill liner provides both a wear element and a lifter bar combination for creating motion and breakage, or comminution, of the solids material being processed in the mill. The arrangement of the inserts across the whole mill liner element means that the integral lifter bar and wear element components are through-strengthened, which is an improvement on the conventional arrangements. The arrangement further simplifies the replacement or repair of the liner elements in the grinding mill drum or shell.

As shown in FIG. 8A, the design consists of multilayer of Steel bonded by a polymer in between. The Steel layers are made of thickness of 25 mm to 150 mm and the polymer separation is about 5 mm to 30 mm. This solution provide a lifter bar highly flexible for damping external forces but enough stiff to avoid excessive deformation of rubber avoiding the fatigue on the rubber bonding layer. Also the quality of the Steel remains same through the entire life of the product and the bonding layer of the internal parts is protected from the external forces and chemical attacks can come from the mineral process.

Most critical part of the herein disclosed design its related to the ability to resist impact by its low stiffness manufacture method, which consider a complete floating solution where the Steel able to move on rubber in case of any kind of external forces (F), reducing the stresses on the Steel (1) and therefore minimizing the plastic deformation on Steel Surface (1), improving considerably the wear performance and toughness of the product since the very beginning of the use.

The front angle of the pyramidal shape liner depends on the mill speed and the charge volume present inside the mill. The Stiffness matrix and the damping coefficient is the most important characteristics of the material. The position and the placement of the multi-layer of the special grades of the steel inside the rubber matrix is very critical to the design process. This pyramidal shape construction and the material property allows the design with right blend of stiffness and damping coefficients.

In the grinding applications, (especially in a SAG mill), impact phenomenon is prevalent. Contact duration and the contact area during any impact is the criterion which decides the contact force and the onset of the adiabatic shear bands in the rubber material. Pressure distribution under the contact area also changes at different instants of impact (which is a restitution period). Elastic deformation develops until the yielding initiates and then the plastic deformation alters the pressure distribution. These two parameter, viz. contact duration and contact area directly depends on the material damping and stiffness coefficients. Pyramidal construction of multilayers of steel inserts spaced between the rubber has a great advantage over the conventional steel liners which reduces the contact force and hence the chances of adiabatic shearing. The resultant normal and the tangential component of the forces are lesser compared to conventional liners (because of rigid body behaviour) under the same loading conditions. Also since wear is a result of the sliding surfaces under the effect of the normal forces. And hence for the geometries which will have lower normal forces will have also lesser wear. Hence Pyramidal shape construction has another advantage of giving higher life over the conventional liners when subjected under same loading conditions.

Since the Pyramidal shape construction has a lower wear rate. It has the ability to retain the profile of the liner attack angle for a longer duration ensuring the advantage on improving the grinding efficiency and lowering the specific energy consumption. The floating design characteristics means a double function of different steel embedded in polymer:

### I) Isolation of Internal Steel

The external layer protect and isolate the second layer of Steel (3 and 4) from the external forces (F) due to the damping of rubber in between the steels 1, 3 and 4. Exactly same process occur when the mil rotate in the opposite direction, where in that case the Steel 2 receive the external forces (P) protecting the layers 3 and 4 in the same way. During all this process its possible to see a single line from the exterior giving a reference of the high worn out.

The internal steel 3 and 4 remain isolated of any chemical agent present in the slurry and isolated of the internal temperature of the mill, during an important time of the total wear life of the product, reducing the risk of failure by fatigue/corrosion in the bonding layer.

### II) Avoid the Excessive Movement of Steel

As per the force F is producing a movement in the same direction to the steel 1, the layer disposition of other steel 2, 3 and 4 floating in rubber allow its movement, but avoid an excessive movement can produce a failure of bonding layer, resulting in a perfect equilibrium of damping and stiffness of the product

In a second phase and as illustrated in FIG. 8(b), as soon as the wear mechanism start to progress, appear the Steel 4 and start to be exposed to the external forces as well as Steel 1 and 2, but still keeping isolated and protected the Steel 3. During this stage of the process you are able to see two lines from the exterior giving a reference of the high worn out.

The third and subsequent phases work in a similar way as shown in FIG. 8(c), and now the Steel 3 start to receive the external forces along with Steel 1, 2 and 4. During this stage is possible to see three lines from the exterior giving a reference of the high worn out.

The manufacturing method its essential for the success of the idea presented. Polymer must be in a single flow apply by compression, keeping the steel on its position and keeping the temperature uniform through the complete process of filling among the steels, without put in touch the steel among themselves.

The curing process its being done by heating up method from an external source of heat transmitted to the product by thermal conduction, starting from outside to the core of the product. The equilibrium temperature must be reached on the bonding layer at the core in a such way to avoid an under cure of the product or an excessive curing of the outside steel layers.

Raw materials used in the design are the steel portion have the capacity to resist impact and abrasive wear by combining a proper hardness through thickness profile and an excellent impact toughness, can be used rolled steel quenched and tempered with surface harness range from 280 to 650 HBN, depending on the operational condition of the mill; but furthermore can used cast insert in different microstructure like pearlitic, martensitic, bainitic, aus-ferritic or a combination of them with similar range of hardness than rolled steel. Forged steel is also another possible combination able to be use in the disposition referred in this invention.

Polymers used to bond the steel can be a combination or not from different kind of polymers like rubber, polyurethane, plastics and others similar.

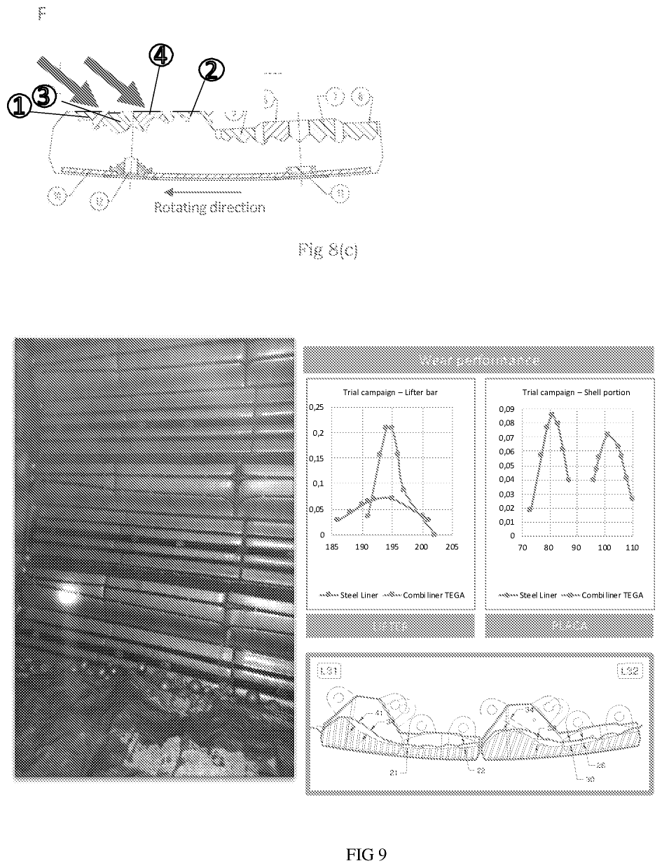

The herein disclosed pyramid lining insert for mill drum has been inducted in trial as shown in FIG. 9 in order to analyze the rate of wear. The Left side picture shows the wear profile at the end of campaign of a Trial done in a SAG 34×17 in order to compare the performance between typical steel liner against a pyramid design. The right side graphs shows the comparative wear measurement of the performance against steel. Average value for steel and pyramid design Lifter bar have similar average height after worn out but pyramid design has a much consistent quality with a narrow distribution of height. In the shell portion the height remaining looks much better than steel.

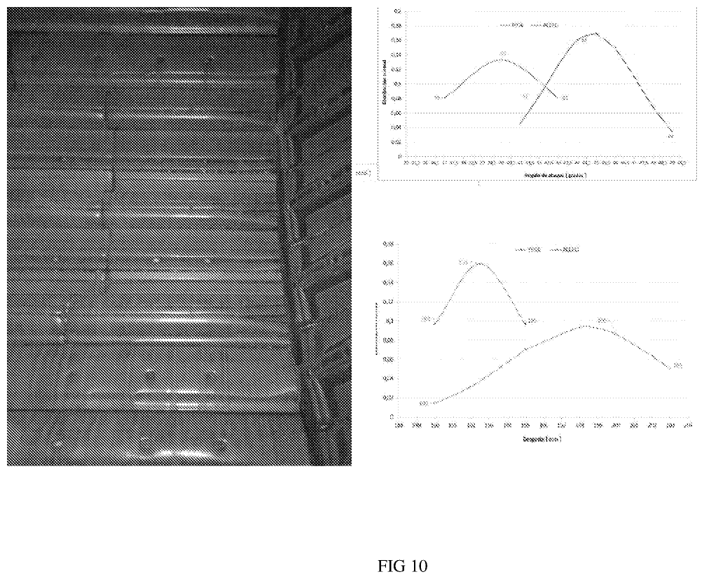

The FIG. 10 shows the wear condition after the rigorous continuous trials and in final inspection after 6 month of operation and around 18Mton processed of a trial Pyramid design in a 40×24 to compare the performance against steel liner. In the right side has been evaluated comparatively the height worn out of the lifter bar steel vs pyramid design, impressive difference and consistency of quality. Also it can be observed that the angle of lifting at the end of campaign remains much better than steel with values between 37-47° in comparison to 42-49° in the steel. This last result means as per the best wear performance of pyramid design against steel will help to keep the lifting capacity on the mill, improving the power consumption and obviously the throughput.

Although the foregoing description of the present invention has been shown and described with reference to particular embodiments and applications thereof, it has been presented for purposes of illustration by way of examples and description and is not intended to be exhaustive or to limit the invention to the particular embodiments and applications disclosed. The particular embodiments and applications were chosen and described to provide the best illustration of the principles of the invention and its practical application to thereby enable one of ordinary skill in the art to utilize the invention in various embodiments and with various modifications as are suited to the particular use contemplated. All such changes, modifications, variations, and alterations should therefore be seen as being within the scope of the present invention as determined by the appended claims when interpreted in accordance with the breadth to which they are fairly, legally, and equitably entitled.

1. A pyramid lining insert/element for mill drum of a grinding mill, comprising of:
a structural and positional formation of pyramid inserts configured with a front lifter part that extends a first side of the liner member with a defined height and a rear lifter part that extends to the rear side conforming shape of pyramid of the said liner member;
wherein both the front and rear lifter part having an height; and
wherein the said front and rear lifter part are adjacent to each other along the side of the said pyramid shaped lining member and have a front and rear support plate beneath the said front and rear lifter part in order to support the lifter plate and also to provide a robust and solid lining member.

2. The pyramid lining insert for mill drum as claimed in claim 1, wherein each insert/element is formed as a multi-layered plate of steel material with a thickness T, which defines an impact edge that is oriented in a direction away from the base surface.

3. The pyramid lining insert for mill drum as claimed in claim 1, wherein the said front and rear support plate said pyramidal lining insert is structured and compounded by a combination of wear resistant high-strength steels embedded into a rubber matrix, in a configuration layout that allows to obtain a high-performance protection element and in turn its steel-alternate configuration allows to determine the level of wear upon visual inspection.

4. The pyramid lining insert for mill drum as claimed in claim 1, wherein the said liner element has a length L extending between a first end and a second end, and a longitudinal axis parallel to the axis of rotation of a grinding mill shell or drum and sized to extend over the entire length of the grinding mill drum or shell (i.e., measured in the direction of rotational axis of the grinding mill shell).

5. The pyramid lining insert for mill drum as claimed in claim 4, wherein the said liner element length L is less than the length of the grinding mill shell.

6. The pyramid lining insert for mill drum as claimed in claim 1, wherein said liner element is having a width W and a base surface with a curvilinear contour made of steel or aluminium, and its dimension depends on the internal diameter of the mill; and
wherein the said base surface extends substantially the width of the mill liner element and is oriented for positioning along the inner wall of a grinding mill shell.

7. The pyramid lining insert for mill drum as claimed in claim 6, wherein said base surface includes backing plate member formed or extends along the base surface of the pyramid shaped liner member;
wherein the backing plate member may be a single, continuous length that extends substantially the length L of the mill liner element.

8. The pyramid lining insert for mill drum as claimed in claim 6, wherein the said backing plate member is a polymeric material composite plate with an embedded internal member having plurality of lengths which are positioned adjacent each other along the internal surface of the mill shell; and
wherein the said internal member is made of any suitably strong and durable material, such as stainless steel, aluminium, steel or alloy.

9. The pyramid lining insert for mill drum as claimed in claim 1, wherein a plurality of said pyramid shaped liner member inserts are embedded on the grinding mill shell in a spaced apart array with polymeric rubber material positioned between adjacent inserts; and
wherein the said plurality of inserts are preferably positioned along the length L of the mill liner element.

10. The pyramid lining insert for mill drum as claimed in claim 1, wherein the said inserts are oriented in a direction that is perpendicular to the longitudinal axis of the mill liner element.

11. The pyramid lining insert for mill drum as claimed in claim 1, wherein the pyramid shaped element/insert are spaced apart from each other in series along the length of the lining and the said inserts are spaced with width X from each other.

12. The pyramid lining insert for mill drum as claimed in claim 1, wherein the thickness T of the inserts is preferably from about 25 mm to about 150 mm.

13. The pyramid lining insert for mill drum as claimed in claim 7, wherein the said steel layout in the wear protection element allows reducing the transverse rubber area exposed to abrasion, and achieving a more uniform wear, and gives anchorage space beneath the anti-abrasive plates to allocate fastening items.

14. The pyramid lining insert for mill drum as claimed in claim 1, wherein the said pyramid shaped inserts are configured with opposing, spaced apart surfaces which define the thickness T of the insert.

15. The pyramid lining insert for mill drum as claimed in claim 1, wherein each said inserts also has a defined height H, where the height H of the insert is greater than the thickness T of the insert; and
wherein the inserts are formed in plurality of configurations.

16. The pyramid lining insert for mill drum as claimed in claim 1, wherein said liner element further includes means for attaching the mill liner insert to said grinding mill shell, through which fastening means are positioned; and
wherein the said fastening means extend through the backing plate, which provides an anchoring device for the fastening apparatus, and into the shell.

17. The pyramid lining insert for mill drum as claimed in claim 16, wherein the said fastening apparatus may be any suitable device, such as bolts, having associated washers and nuts.

18. The pyramid lining insert for mill drum as claimed in claim 1, wherein the positioning of a plurality of mill liner elements is along the inner circumferential wall of the mill shell;
wherein the said mill elements are positioned adjacent to each other about the entire inner wall of the grinding mill shell with the longitudinal axis of each mill liner element being oriented parallel to the rotational axis of the grinding mill shell; and
wherein the backing plate of each mill liner element, is curved to conform to the curvature of the mill shell.

19. The pyramid lining insert for mill drum as claimed in claim 11, wherein the elastomer material of the mill liner elements also reduces the noise level during operation of the grinding mill.

20. The pyramid lining insert for mill drum as claimed in claim 1, wherein the said liner element includes a wear element as well as a lifter bar element, and provides both a wear element and a lifter bar combination for creating motion and breakage, or comminution, of the solids material being processed in the mill.

21. The pyramid lining insert for mill drum as claimed in claim 1, wherein the steel plates are made of thickness of preferably 25 mm to 150 mm and the minimum polymer separation is preferably 5 mm.

22. The pyramid lining insert for mill drum as claimed in claim 1, wherein the said mill element is configured to resist impact by its low stiffness polymeric material, which is a complete floating solution where the Steel is able to move on rubber in case of any kind of external forces (F), reducing the stresses on the Steel (1) and therefore minimizing the plastic deformation on Steel Surface (1), thereby improving the wear performance and toughness; and
wherein the external layer protects and isolates the second layer (3 and 4) of Steel from the external forces (F) due to the damping of rubber in between the steels.

23. The pyramid lining insert for mill drum as claimed in claim 22, wherein the internal steel 3 and 4 of the mill element remain isolated from any chemical agent present in the slurry and isolated from the internal temperature of the mill, thereby increasing the wear life of the product, and reducing the risk of failure by fatigue/corrosion in the bonding layer.

24. The pyramid lining insert for mill drum as claimed in claim 1, wherein mill element is configured for visualization of external wear and tear by a view of one, two or three straight lines during mill operation by giving a reference of the stage of wear.

25. The pyramid lining insert for mill drum as claimed in claim 1, wherein raw materials used in the said steel portion is configured to resist impact and abrasive wear by combining a proper hardness through thickness profile and an impact toughness, with surface harness range from 280 to 650 HBN; and
wherein the polymers used to bond the said steel plates are a combination from different kind of polymers like rubber, polyurethane, PVC, plastics and the like.
